(19) United States
(12) Patent Application Publication
(10) Pub. No.: US 2015/0340792 A1
(43) Pub. Date: Nov. 26, 2015

(54) CONTACT HAVING A RESISTANT PRIMARY LANCE FOR LOCKING IN A CONTACT CHAMBER OF A PLUG-IN CONNECTOR

(71) Applicant: Robert Bosch GmbH, Stuttgart (DE)

(72) Inventors: Zhenyu HU, Leonberg (DE); Ulrich SCHMATZ, Besigheim (DE)

(21) Appl. No.: 14/405,583

(22) PCT Filed: Apr. 4, 2013
(86) PCT No.: PCT/EP2013/057068

§ 371 Date: Dec. 4, 2014

(30) Foreign Application Priority Data
Jun. 4, 2012 (DE) 10 2012 209 423.7

(51) Int. Cl. H01R 13/436; H01R 4/18; H01R 4/16

(52) U.S. Cl. CPC H01R 13/436; H01R 4/16; H01R 4/18

(57) ABSTRACT

A contact for a plug-in connector is provided, including a housing and an inwardly deflectable primary lance which is mounted in the housing interior. A locking subarea of the primary lance protrudes outwardly from the side through an opening. The contact also includes a contact surface between the housing and the primary lance for absorbing a pull-out force.

### FIELD OF THE INVENTION

The present invention relates to a contact for a plug-in connector, and in particular a plug which is equipped with such a contact.

### BACKGROUND INFORMATION

It is frequently necessary, in particular in vehicle manufacturing, to connect electrical lines to one another. For example, cables must be joined together or connected to electrical devices. For this purpose, plug-in connectors in the form of plugs, for example, are often used, in which one or multiple contact chamber(s) is/are provided in a plug housing. A contact which is connected to an electrical line is situated in each of the contact chambers and locked therein. The contact is designed for establishing an electrically conductive connection with a correspondingly designed mating contact of a mating plug or a socket as soon as the plug is connected to the mating plug or the socket.

During the manufacture of such plugs, the contacts, at the rear end of which the associated cables are crimped, are pushed into the individual contact chambers. To prevent the contacts from sliding out of the contact chamber when the cables are pulled, for example, the contacts are usually locked in the contact chambers in a form-fit manner. In one frequently used design of the contacts, for this purpose an outwardly protruding and inwardly deflectable primary lance is provided on the housing of the contact. This primary lance protrudes outwardly at an angle beyond the housing of the contact, against an insertion direction in which the contact is pushed into the contact chamber during assembly of the plug-in connector. When the contact is pushed into the contact chamber, the primary lance is initially inwardly elastically deformed in order to subsequently be able to spring back into a recess in the contact chamber when the primary lance reaches its target position, in order to thus lock the contact in the contact chamber.

German Published Patent Application No. 10 2009 054705 A1 describes an electrical contact for plug-in connections, having an outwardly protruding and inwardly deflectable primary lance.

In particular for use in motor vehicles, high mechanical demands are placed on plug-in connectors and the contacts inserted therein. On the one hand, for easily fitting the contacts into the contact chambers, the primary lance should elastically deflect with a preferably small force and subsequently return to its starting position in order to be able to easily and reliably lock a contact in a contact chamber.

On the other hand, the locking of the contacts within the contact chambers of the plug should preferably be reliable and secure in order to prevent the contacts from being accidentally pulled out, for example when the cables which are crimped to the contacts are pulled.

In particular for miniaturized contacts, in which high mechanical demands are imposed despite a small installation size and small material thicknesses, it may be difficult to meet these conflicting requirements.

### SUMMARY

According to specific embodiments of the present invention, a contact for a plug-in connector is provided, in which functions necessary for the fitting or mounting operations in a contact chamber are separated, and may be implemented from different areas of the contact or from the primary lance of the contact. This separation allows separate optimization of the primary lance with regard to the insertion behavior of the contact into a contact chamber as well as the mounting of the contact in a contact chamber. Thus, on the one hand, during a fitting operation the outwardly protruding primary lance may be inwardly deflected in an elastic subarea with little effort due to elastic spring properties, and for locking the contact in the contact chamber may spring back into the starting position. On the other hand, the primary lance may be designed in such a way that with a locking subarea it resists a pull-out force against the insertion direction.

The contact according to the present invention includes an elongated housing which is designed in such a way that it encloses a housing interior, and may be pushed into a contact chamber of a plug-in connector in an insertion direction. In addition, the contact includes an elongated primary lance which at least partially protrudes laterally beyond the housing in a first state in which no force acts on the primary lance transversely with respect to a longitudinal axis of the housing. A first end of the primary lance is connected to the housing in the housing interior. The housing has an opening on the side through which the locking subarea of the primary lance protrudes in the first state. The housing has a contact surface at the opening. The locking subarea of the primary lance and the contact surface are designed and situated relative to one another in such a way that the locking subarea comes into contact with the contact surface when a force acts on the locking subarea in the insertion direction in a second state. Such a force which acts in the insertion direction may occur, for example, when a tension against the insertion direction is exerted on a cable which is crimped on the contact, and therefore the locking subarea which is locked in a contact chamber experiences a force in the insertion direction. The contact surface at the housing opening and the locking subarea should be designed in such a way that at least one component of the force which acts in the insertion direction is transmitted to the contact surface.

The concept of the contact designed in this way may be considered to be that as the result of a special design of the primary lance, a functional and spatial separation of the functional areas may be carried out on the one hand for the elastic deflection of the primary lance in the housing interior, and on the other hand for keeping the contact in the contact chamber by absorbing a pull-out force. The contact surface at the housing opening, due to its cooperation with the locking subarea which protrudes through the opening, allows a distribution of the overall force over the surface, and thus the absorption of higher pull-out forces, which, unlike the case in conventional contacts, do not act primarily on the partially deformable primary lance itself and its fastening to the housing of the contact, but instead may be absorbed by the rigid housing edge at the opening. This has the advantage that much smaller forces act on the remaining area of the primary lance in the housing interior, and therefore a plastic deformation or even breakage of the lance under high pull-out forces may be prevented. In addition, in this way a much larger pull-out force may be absorbed by the contact, in particular for a miniaturized design.

To allow an effective engagement of the contact surface, provided at the edge of the opening, with the locking subarea of the primary lance, the primary lance may be designed in such a way that in the second state which is acted on by force in the insertion direction, a portion of the locking subarea which laterally protrudes beyond the housing as well as a portion of the primary lance situated in the housing interior protrude beyond the contact surface in the insertion direction.

In other words, in the insertion direction the primary lance may have a curvature, for example, whose inner area receives within it the contact surface at the edge of the opening in the housing when a force is applied in the insertion direction. Due to the force, the locking subarea of the primary lance is pushed in the insertion direction and pressed against the edge of the opening, so that the force at least partially acts on the contact surface and is transmitted to the housing edge. This may have the advantage that the primary lance forms a sufficiently large contact surface with the housing, even in the event of slight displacements or deformations, and unintended sliding or bending of the locking subarea into the housing interior is prevented. In this way, a pull-out force may be transmitted virtually completely to the housing, and may thus contribute to relieving stress on the primary lance. Another possible advantage is that the primary lance may thus have a very material- and space-saving design without impairing the mechanical properties.

The housing may have a bulge in the area of the contact surface which results in enlargement of the effective contact surface. This larger contact surface may result in better surface distribution of the acting pull-out force and may reduce the likelihood of deformations, displacements, or abrasion of the contact surface. An enlarged contact surface thus allows the absorption of larger pull-out forces.

In an area which has a maximum lateral protrusion beyond the housing, the locking subarea may have a sliding surface which is angled downwardly with respect to the surface of the housing in the insertion direction. This allows the contact to be pushed into the contact chamber with little effort by sliding a wall of the contact chamber onto the primary lance along the sliding surface, against the insertion direction, thus generating a force on the primary lance, in the direction of the housing interior, which deflects the primary lance into the housing interior.

In one advantageous embodiment according to the present invention, in an elastic subarea between the fastened first end of the primary lance and the locking subarea, the primary lance has greater elasticity in a direction transverse to the longitudinal axis of the housing than in the locking subarea. This allows the primary lance to already be inwardly deflected with a small force due to deformation of the elastic subarea when the contact is pushed in, and at the same time allows a more rigid design of the locking subarea for an increased pull-out force.

The elastic subarea as well as the locking subarea may be curved, the locking subarea preferably having a smaller radius of curvature than the elastic subarea. Due to these differing radii, different stiffnesses in the areas of the primary lance may be achieved. As a result of the different geometric and material designs of the bends, the sliding characteristic and spring characteristic of the primary lance, in particular during insertion and locking into a contact chamber, may be influenced.

In another advantageous specific embodiment, the locking subarea has a Ω shape in a section plane along the longitudinal axis of the housing. This shape may allow the described functions to be implemented in an effective, space-saving manner. A front area of the Ω-shaped locking subarea may cooperate with the contact surface at the housing opening under stress in the insertion direction. An upper area of the Ω-shaped locking subarea may act as a sliding surface. A rear area of the Ω-shaped locking subarea may prevent the locking subarea from becoming greatly deformed and sliding out of the housing opening under stress in the insertion direction, which would reduce its ability to absorb forces acting in the insertion direction.

In addition, the locking subarea may be U-shaped in a section plane transverse to the longitudinal axis of the housing. A very rigid profile may thus be formed in the area of the locking subarea, it being possible to influence the deflection behavior of the primary lance, for example via the type and design of the transition between the preferably flat elastic subarea and the U-shaped locking subarea, and via the length of the elastic subarea.

In addition, the primary lance may have a second end which is situated in the housing interior and which protrudes beyond an edge of the lateral opening inside the housing, against the insertion direction. The advantage of this second end may be additional security against the primary lance sliding or bending out of the opening, and against plastic deformation of the locking subarea of the primary lance when very high pull-out forces occur. When a force acts on the locking subarea in the insertion direction, the second end may be supported on the inner side of the rear edge of the housing recess, and may thus prevent the primary lance at its self-supporting second end from sliding out of the interior of the end housing, which in the worst case could result in severe deformation of the primary lance. Thus, with the aid of this second end the maximum absorbable pull-out force may be even further increased.

It is pointed out that various features and advantages of specific embodiments of the contact and the plug according to the present invention are described herein. Those skilled in the art will recognize that the features may be suitably combined with one another to achieve further advantageous embodiments, effects, and synergistic effects.

### BRIEF DESCRIPTION OF THE DRAWINGS

FIG. 1 shows an exploded view of a plug.

FIG. 2 shows a schematic three-dimensional illustration of a first exemplary embodiment of the contact according to the present invention for a plug-in connector.

FIG. 3 shows a schematic sectional illustration in the longitudinal direction of another exemplary specific embodiment of the contact according to the present invention for a plug-in connector.

FIG. 4 shows a schematic three-dimensional illustration of another exemplary embodiment of the contact according to the present invention for a plug-in connector having a U-shaped locking subarea.

FIG. 5 shows a schematic sectional illustration in the longitudinal direction of another exemplary embodiment of the contact according to the present invention for a plug-in connector having a U-shaped locking subarea.

### DETAILED DESCRIPTION

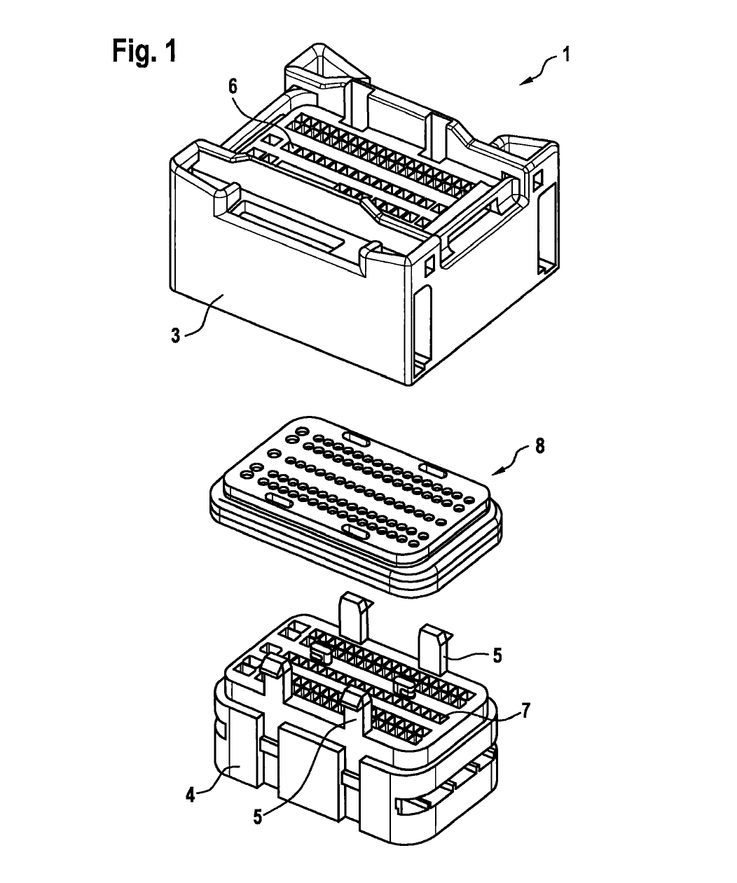

FIG. 1 shows an example of a plug 1 which may be mechanically and electrically designed for combination with a corresponding mating plug (not illustrated in FIG. 1). Plug 1 may be used, for example, for mechanically and electrically joining multiple cables together or connecting a cable harness to a control unit in a motor vehicle. Plug 1 may contain a plurality of individual plug-in connectors which have the respective contacts and contact chamber, and which in each case establish connections for an electrical conductor.

Plug 1 includes an upper housing part 3 and a lower housing part 4 which may be mechanically connected to one another via detent clips 5. A mat seal 8 is situated between upper housing part 3 and lower housing part 4. Leadthroughs 6 for mechanically stabilizing the particular electrical line are provided in upper housing part 3, and associated contact chambers 7 are provided in lower housing part 4. The cables and the contacts (not illustrated in FIG. 1) fastened at the end thereof are introduced through leadthroughs 6 in upper housing part 3 and through mat seal 8 into lower housing part 4, and fastened in contact chambers 7 in a locking manner.

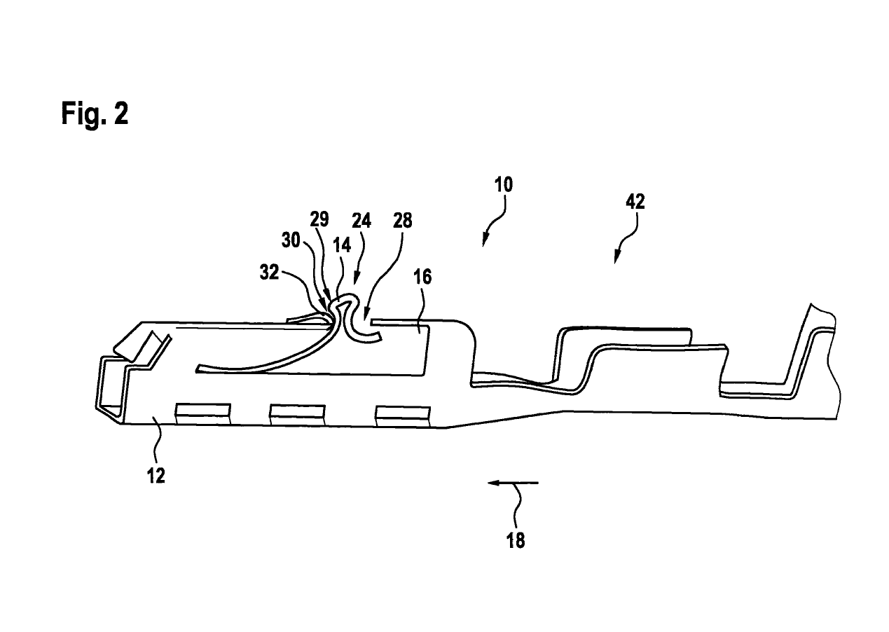

FIG. 2 shows a contact 10, composed of a housing 12 and a crimped area 42, in a schematic three-dimensional illustration according to one exemplary specific embodiment of the present invention. Crimped area 42 is used for mechanically and electrically connecting an electrical conductor to contact 10 by crimping. Housing 12 may have a square, circular, or rounded cross section. Housing 12 has an elongated shape in insertion direction 18. Housing 12 encloses a housing interior 16. A portion of housing 12 is illustrated open on the side for a better view.

A primary lance 14 is mounted on housing 12 in housing interior 16, and with a so-called locking subarea 24 partially protrudes from the side of housing 12 through an opening 28. A front contact area 29 of the protruding portion is situated in the proximity of a bulge 32 which is formed at opening 28 in housing 16.

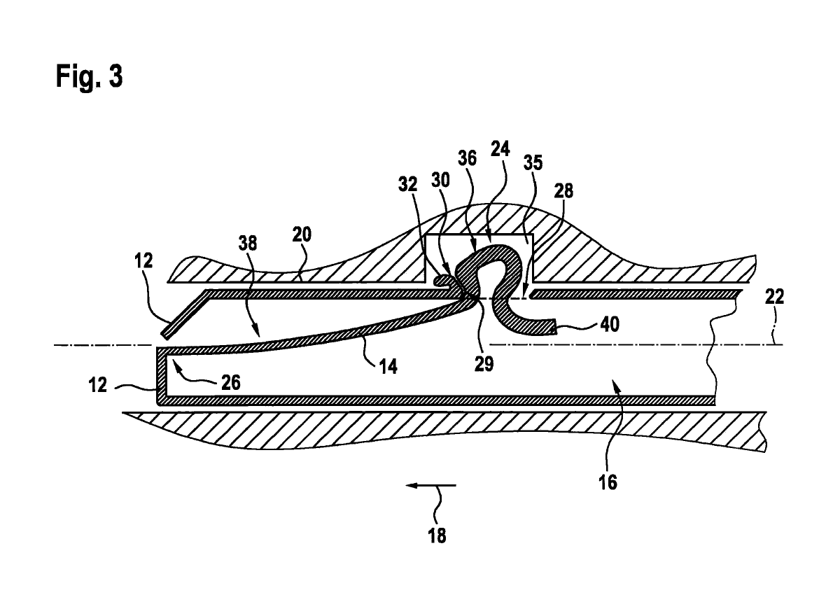

FIG. 3 shows a sectional illustration in the longitudinal direction of the detailed design of contact 10, which is pushed into a contact chamber 20 of a plug-in connector and locked, according to one exemplary embodiment of the present invention. Housing 12 has opening 28 through which primary lance 14 is guided and fastened at its first end 26 in the interior of housing 12. Housing 12 and primary lance 14 may have a one-piece or one-part design, and, for example, may be punched and/or bent using the same metal sheet. Primary lance 14 may be connected to housing 12, for example to the inner side walls or end-face walls, at various locations in housing interior 16. Primary lance 14 is subdivided into an elastic subarea 38 and a locking subarea 24. Locking subarea 24, which in the present case has a Ω shape, includes a second self-supporting end 40, and in the insertion direction includes contact area 29, which is situated in the proximity of bulge 32 of housing 12.

When contact 10 is pushed into contact chamber 20, an edge of contact chamber 20 slides onto a sliding surface 36 of primary lance 14 and generates a force transverse to insertion direction 18 which causes a deflection of primary lance 14 into interior 16 of housing 12. When the contact reaches its end position within contact chamber 20, primary lance 14 with its locking subarea 36 locks with elastic resilience into a recess 35 in contact chamber 20.

When a pull-out force acts on contact 10 against insertion direction 18, locking subarea 24 in the latched-in state is pushed and pressed against a wall of the recess in contact chamber 20. The resulting counterforce in insertion direction 18 is relayed, via the locking subarea, at least partially to contact surface 30 at opening 28 in housing 12. The situation may thus be prevented that the pull-out force causes excessive bending or damage to primary lance 14, in particular in its easily bendable elastic subarea 38 or at the connection to housing 12.

Locking subarea 24 may be designed in such a way that a limited elastic resilience effect of contact 10 against the insertion direction is achieved when a pull-out force acts, in order to achieve, for example, a “soft” stop for avoiding a high pull-out force amplitude.

Bulge 32 of housing 12 allows this force to be distributed over a fairly large contact surface 30. A bulge of the housing wall at opening 28 may be achieved, for example, by bending or crimping the housing wall. It is also possible to make use of the material which is punched out for opening 28.

According to another exemplary embodiment, locking subarea 24 of primary lance 14 may be designed in such a way that locking subarea 24, and thus primary lance 14, is pressed into housing interior 16 when a maximum pull-out force is exceeded. This may allow detaching or unlocking of contact 10 from contact chamber 20 in order to prevent contact 10 from being mechanically damaged by excessively high pull-out forces. This variant is likewise advantageous for maintenance or repair, for example for the replacement of damaged cables or contacts 10.

A curvature of primary lance 14 in insertion direction 18 in the area of bulge 32 and of contact surface 30 allows a secure fit of primary lance 14 at the edge of opening 28 and of bulge 32, so that, in the event of possible displacement or twisting of locking subarea 24, the best possible contact of primary lance 14 against contact area 30, and thus, a preferably large contact surface 30, is made possible. Due to the large radius of primary lance 14 in the elastic subarea, contact 10 may be inserted or fitted into contact chamber 20 within the elastic deformation area with a comparatively small force.

Due to subdividing primary lance 14 into elastic subarea 38 for easily deflecting primary lance 14 into housing interior 16, and the locking subarea for absorbing the pull-out force, both areas are separated in terms of function and force, and may be separately adapted to the particular mechanical requirements.

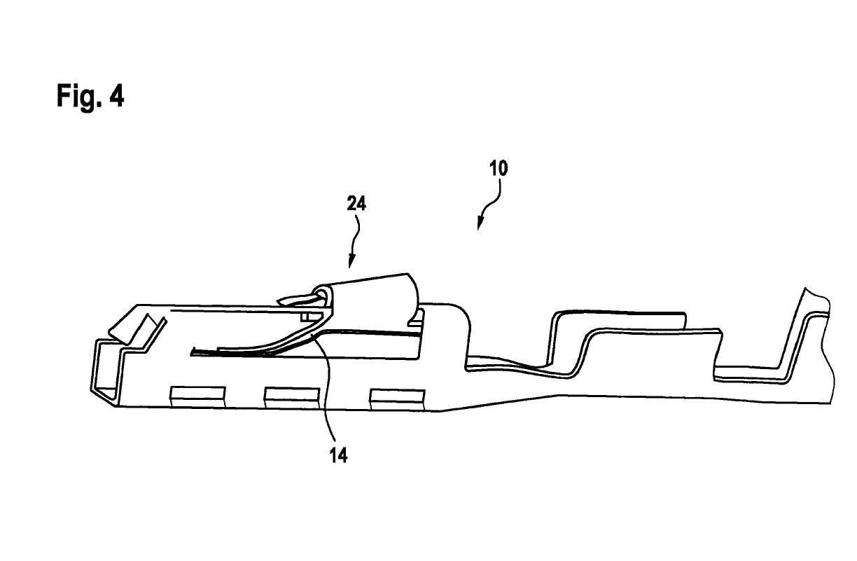

FIG. 4 shows a three-dimensional schematic illustration of another exemplary specific embodiment of the present invention, in which locking subarea 24 has a U-shaped design. The properties of primary lance 14, in particular its elasticity under a force which is directed into housing interior 16, may be influenced via the design of a transition between locking subarea 24 and elastic subarea 38, and via the length of elastic subarea 38. Primary lance 14 together with locking subarea 24 may be produced, for example, from a stamped and bent metal sheet. The U-shaped profile of locking subarea 24 forms a very rigid profile which may be suitable, for example, for absorbing very high pull-out forces.

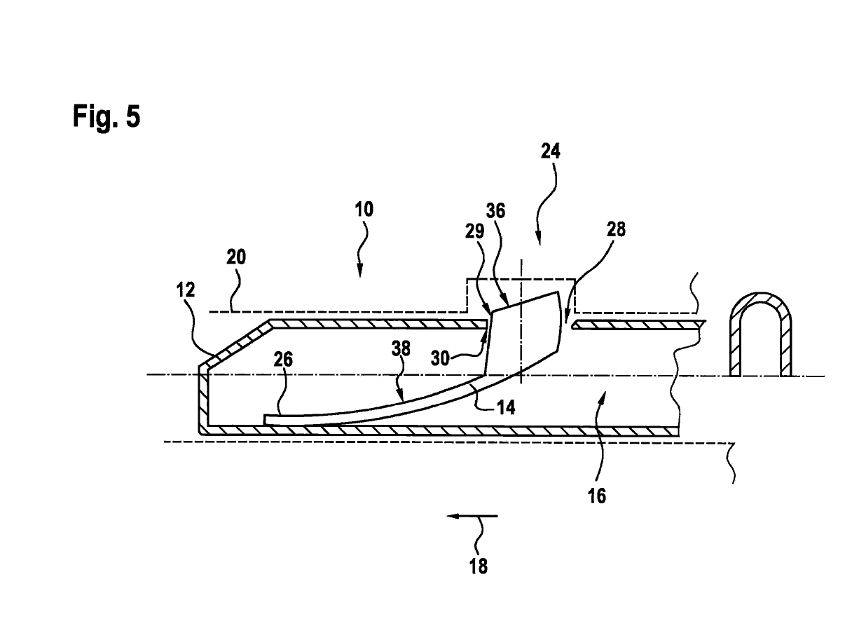

FIG. 5 shows the exemplary embodiment of a contact 10 illustrated in FIG. 4 with the aid of a two-dimensional sectional view in the longitudinal direction. Locking subarea 24 is designed as a U profile. Housing 12 of contact 10 is locked in a contact chamber 20. Primary lance 14 is fastened at one end 26 in the interior of housing 12. When contact 10 is pushed into contact chamber 20, primary lance 14 is deflected onto sliding surface 36 in the direction of housing interior 16 by sliding on an inner wall of contact chamber 20. When a pull-out force acts, primary lance 14 with contact area 29 of its locking subarea 24 is supported on contact surface 30 of housing 12 for absorbing the pull-out force.

1.-11. (canceled)

12. A contact for a plug-in connector, comprising:
an elongated housing;
a contact chamber; and
an elongated primary lance, wherein:
the housing encloses a housing interior and is designed to be pushed into a contact chamber in an insertion direction,
the primary lance at least partially protrudes laterally with a locking subarea beyond the housing in a first state in which no force acts on the primary lance transversely with respect to a longitudinal axis of the housing,
a first end of the primary lance is connected to the housing in the housing interior,
the housing includes a lateral opening,
the primary lance protrudes through the lateral opening in the first state,
the housing has a contact surface at the lateral opening, and
the locking subarea and the contact surface are designed and situated relative to one another in such a way that the locking subarea comes into contact with the contact surface when a force acts on the locking subarea in the insertion direction in a second state, and that at least one component of the force which acts in the insertion direction is transmitted to the contact surface.

13. The contact as recited in claim 12, wherein the primary lance is designed in such a way that in the second state, a portion of the locking subarea which laterally protrudes beyond the housing as well as a portion of the primary lance situated in the housing interior protrude beyond the contact surface in the insertion direction.

14. The contact as recited in claim 12, wherein the housing has a bulge in an area of the contact surface.

15. The contact as recited in claim 12, wherein in an area which has a maximum lateral protrusion beyond the housing, the locking subarea has a sliding surface which is angled downwardly with respect to the contact surface of the housing in the insertion direction.

16. The contact as recited in claim 12, wherein in an elastic subarea between a first end of the primary lance and the locking subarea, the primary lance has greater elasticity in a direction transverse to the longitudinal axis of the housing than in the locking.

17. The contact as recited in claim 16, wherein the elastic subarea and the locking subarea are curved, the locking subarea having a smaller radius of curvature than that of the elastic subarea.

18. The contact as recited in claim 12, wherein the locking subarea has a Ω shape in a section plane along the longitudinal axis of the housing.

19. The contact as recited in claim 12, wherein the locking subarea is U-shaped in a section plane transverse to the longitudinal axis of the housing.

20. The contact as recited in claim 16, wherein the primary lance has a second end situated in the housing interior and protruding beyond an edge of the lateral opening in the housing, against the insertion direction.

21. The contact as recited in claim 12, wherein the primary lance and the housing are formed in one piece from the same metal sheet by bending and punching.

22. A plug-in connector, comprising:
a contact for a plug-in connector, comprising:
an elongated housing;
a contact chamber; and
an elongated primary lance, wherein:
the housing encloses a housing interior and is designed to be pushed into a contact chamber in an insertion direction,
the primary lance at least partially protrudes laterally with a locking subarea beyond the housing in a first state in which no force acts on the primary lance transversely with respect to a longitudinal axis of the housing,
a first end of the primary lance is connected to the housing in the housing interior,
the housing includes a lateral opening,
the primary lance protrudes through the lateral opening in the first state,
the housing has a contact surface at the lateral opening, and
the locking subarea and the contact surface are designed and situated relative to one another in such a way that the locking subarea comes into contact with the contact surface when a force acts on the locking subarea in the insertion direction in a second state, and that at least one component of the force which acts in the insertion direction is transmitted to the contact surface.
